(19) United States
(12) Patent Application Publication
(10) Pub. No.: US 2006/0145511 A1
(43) Pub. Date: Jul. 6, 2006

(54) Motorcycle Fender Bra

(76) Inventor: J. Michael Traher, Tucson, AZ (US)

Correspondence Address: J. Michael Traher, 5625 N. Campbell Ave., Tucson, AZ, 85718, US

(21) Appl. No.: 10/905,494

(22) Filed: Jan. 6, 2005

(51) Int. Cl. B60J 11/00

(52) U.S. Cl. 296/136.07

(57) ABSTRACT

The Motorcycle Fender Bra is a readily installable/removable cover that protects the lower part of a motorcycle front fender from road debris. The Bra is made of soft leather or vinyl and is curved in the shape of a slightly concave half moon, with an underside leather or vinyl pouch and nylon straps that wrap around the motorcycle forks and snap together with a standard utility clip.

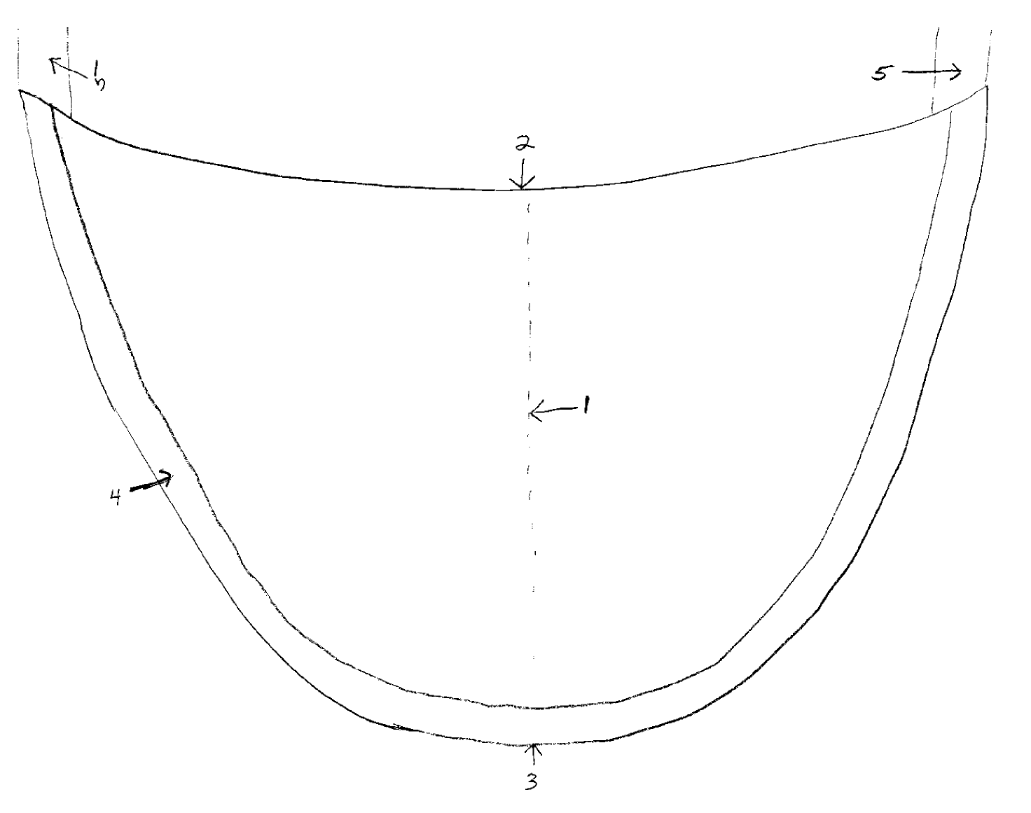

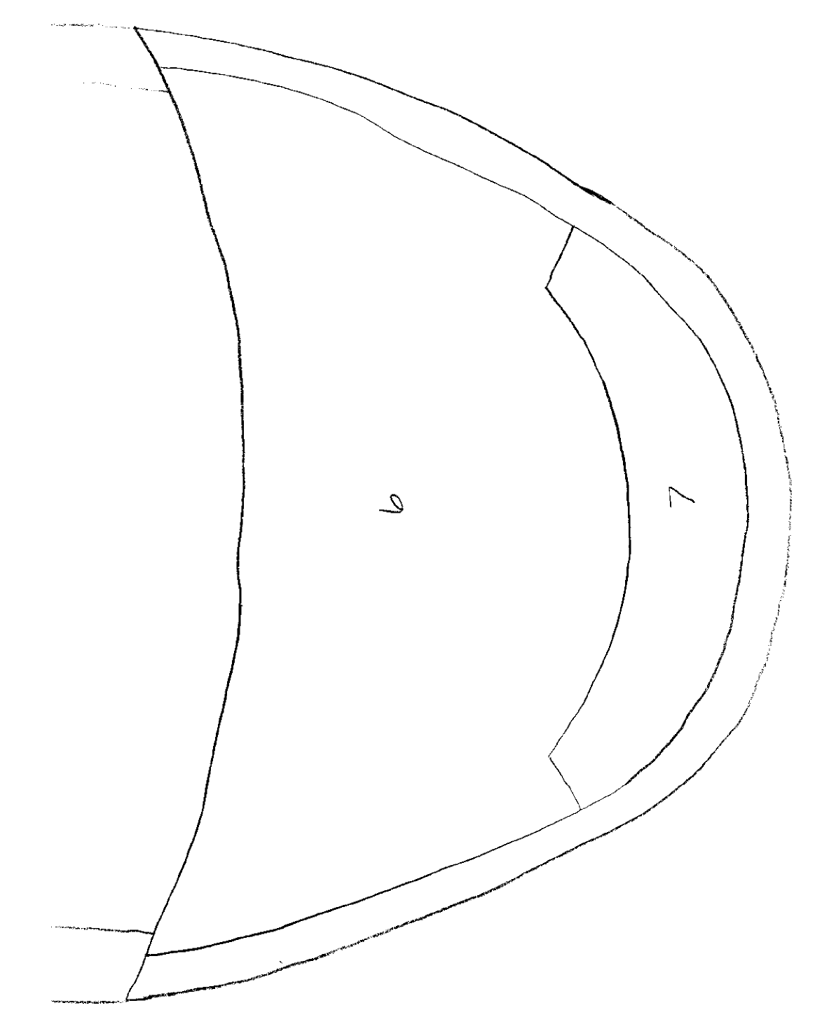

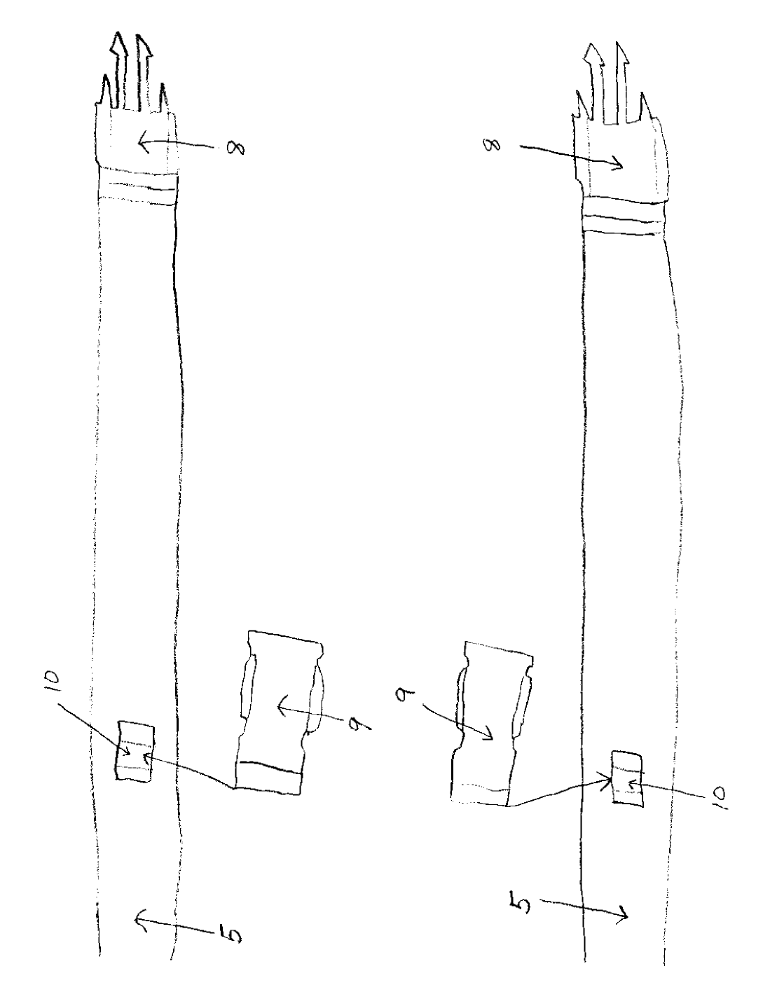

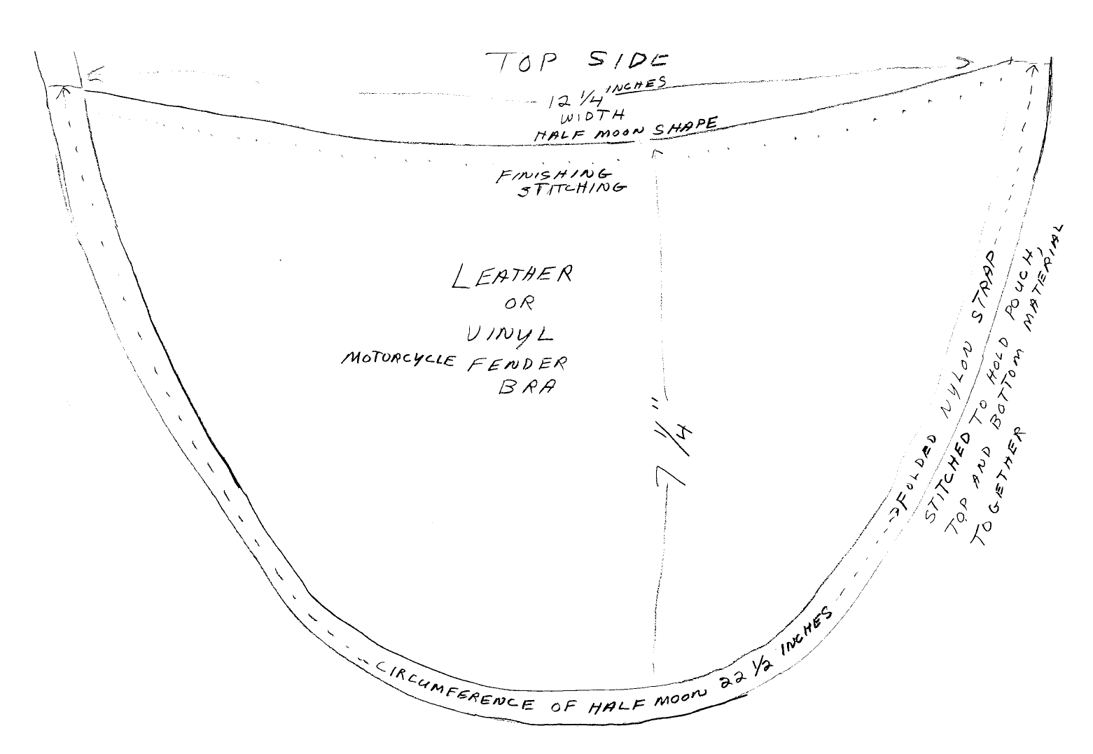

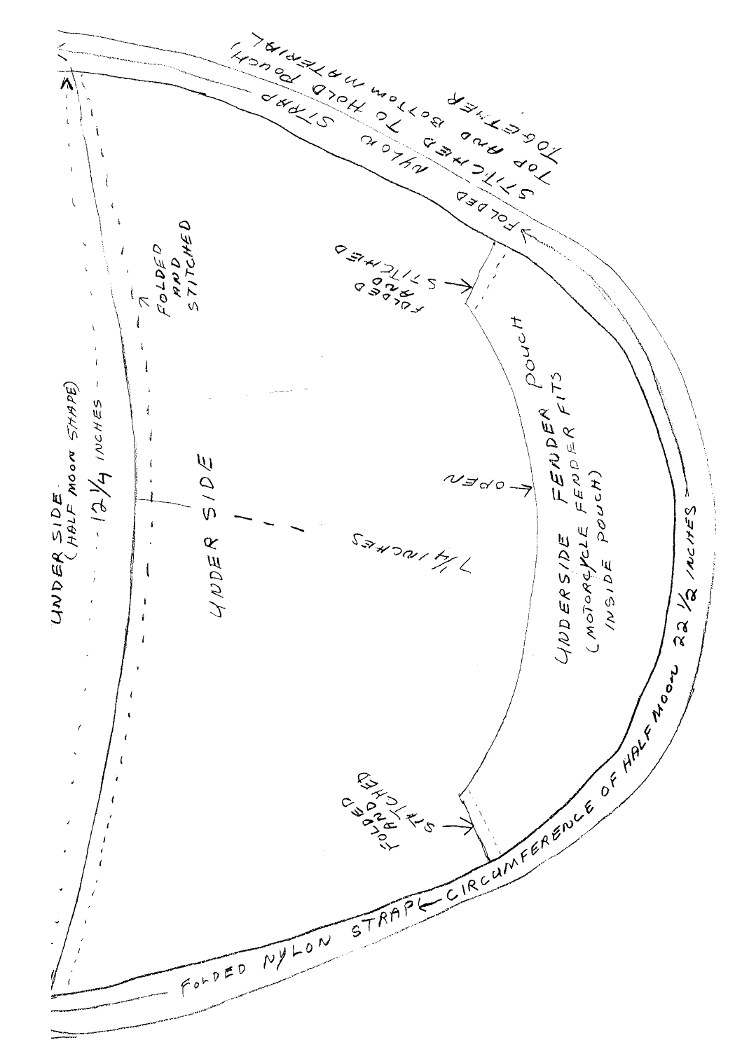

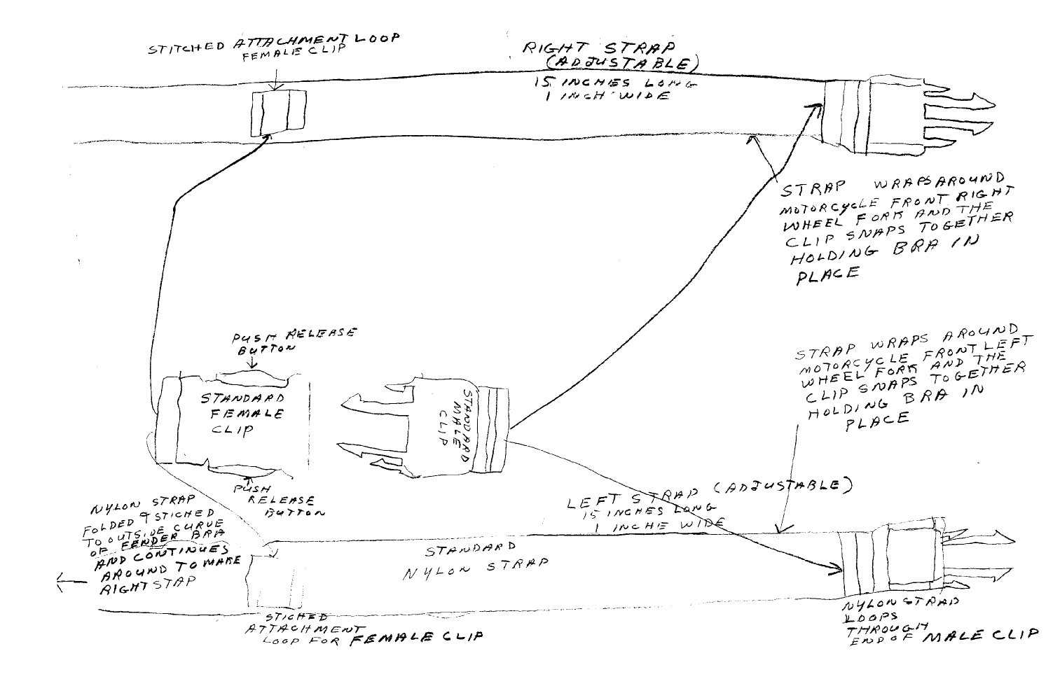

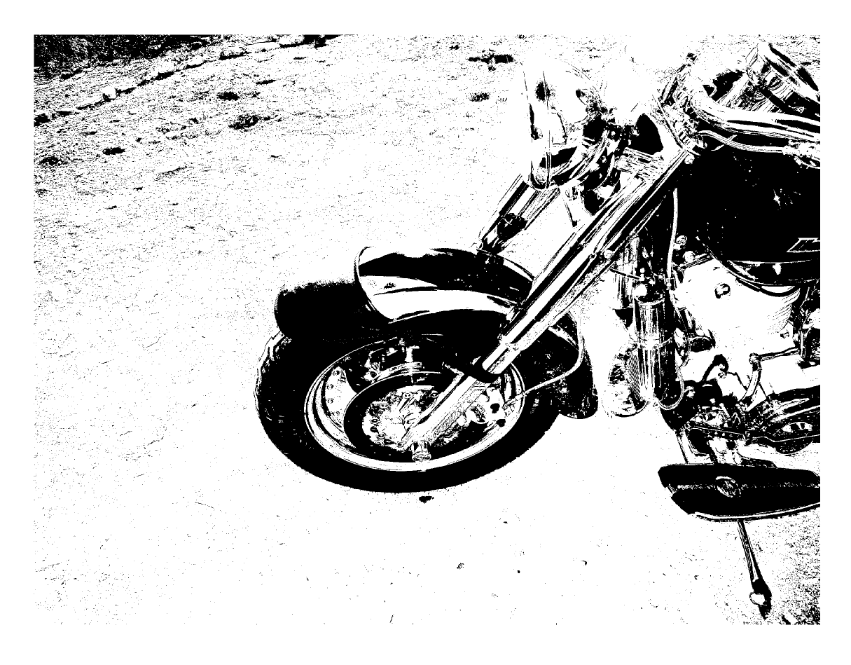

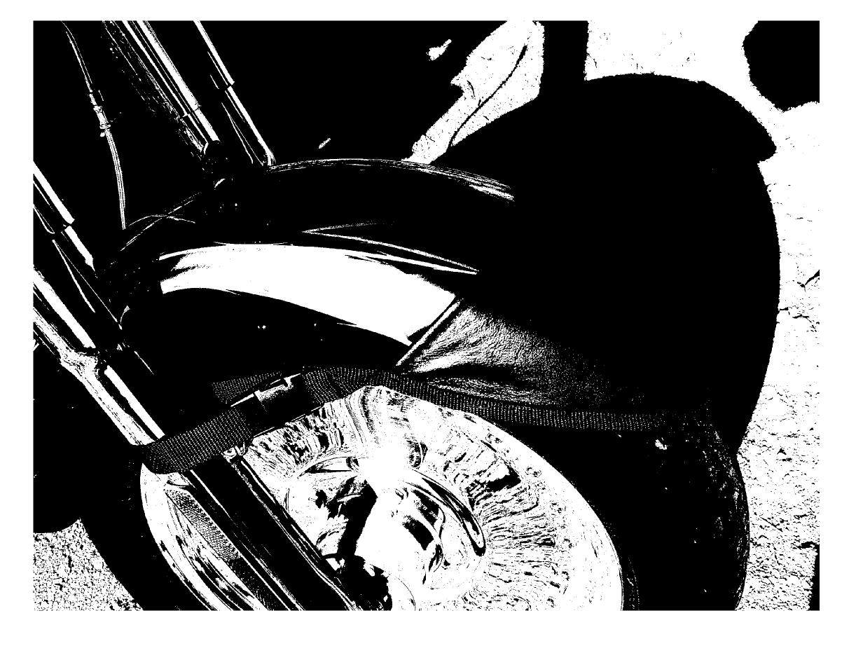

General Description: This is a Motorcycle Fender Bra (the “Bra”) that is made of soft leather or vinyl and covers the lower front portion of the front fender of a motorcycle to eliminate damage to the fender and paint from small rocks and debris that are commonly kicked up by cars and trucks that are riding in front of the motorcycle.

Dimensions and Design Specifications: The Bra is 7¼ inches from the center front tip of the Bra to the top center of the Bra (see reference Number 1 in Drawings). The width of the Bra is 12¼ inches (reference Number 2 in Drawings). The half moon circumference is 22½ inches (reference Number 3 in Drawings). A 1 inch nylon strap is folded and sewn around the circumference of the Bra (see reference Number 4 in Drawings) and extends flat 15 inches on each side of the Bra (see reference Number 5 in Drawings). It has a 1½ inch curved pouch that is sewn on the underneath (see reference Number 6 in Drawings) side of the Bra to allow the front tip of the fender to fit in the pouch (see reference Number 7 in Drawings). The strap has a standard plastic utility male clip (see reference Number 8 in Drawings) on each end and a standard plastic utility female clip (see reference Number 9 in Drawings) is sewn (see Reference Number 10 in Drawings) on the strap 13 inches from the end of the strap on each side. The Bra with its finished leather or vinyl side up, sits on top of the front fender with tip of fender inside the underneath pouch and the straps then wrap around the left and right front fork bars of the motorcycle. The male clip is adjusted for strap length to fit taut and is snapped into the female clip, with the pouch and the tension from the straps holding the Bra in place.

What is claimed is:

1. A Motorcycle Fender Bra that covers the lower portion of a motorcycle front fender, which is the most vulnerable part of the fender. The Bra protects the fender and paint from road debris. Small rocks and debris glance off the Bra without nicking or marring the surface of the fender. The Bra is made of soft leather or vinyl and will not scratch or mar the surface of the fender. The unique design of the Bra allows a motorcycle rider to easily install the Bra when he is going on the road and quickly remove it when he parks the motorcycle. The design allows the motorcycle owner to easily use multiple Bras made of different colors and to place his own personal logos, patches and embroidered surface designs on the Bra. The adjustable design of the Bra straps also makes it compatible with all types of motorcycle.
